(19) United States
(12) Patent Application Publication
(10) Pub. No.: US 2004/0214131 A1
(43) Pub. Date: Oct. 28, 2004

(54) Spot curing lens used to spot cure a dental appliance adhesive and systems and methods employing such lenses

(75) Inventors: Dan E. Fischer, Sandy, UT (US); Bruce S. McLean, Sandy, UT (US)

Correspondence Address: John M. Guynn, WORKMAN, NYDEGGER & SEELEY, 1000 EAGLE GATE TOWER, 60 EAST SOUTH TEMPLE, SALT LAKE CITY, UT, 84111, US

(73) Assignee: Ultradent Products, Inc.,

(21) Appl. No.: 10/423,278

(22) Filed: Apr. 25, 2003

(51) Int. Cl. A61C 3/00

(52) U.S. Cl. 433/29

(57) ABSTRACT

A spot curing lens can be used with a dental light curing device for spot curing an overlay, inlay, veneer, crown, or other dental appliance to a patient's tooth. The spot curing lens and related method allows a dental practitioner to spot cure a portion of a light curable adhesive between a veneer or other dental appliance and substrate, such as a tooth, remove any excess uncured adhesive from around the perimeter of the appliance, and then finish curing any uncured adhesive that remains between the appliance and substrate surface. This eliminates the need for grinding, breaking, or scraping cured and hardened excess adhesive material from around the appliance.

### BACKGROUND OF THE INVENTION

1. The Field of the Invention

The present invention relates to the field of dentistry, particularly to dental light curing devices used to cure dental cements during installation of dental veneers, crowns, and other restorative appliances, and procedures for installing such appliances. More particularly, the invention is in the field of lenses that are attached to light curing devices and methods of use.

2. The Relevant Technology

Light curing devices are employed to polymerize and cure light curable compositions (also referred to herein as adhesives or resins) in a variety of industries. Light curing devices include a light source which emits light energy for curing a light curable composition. In the field of dentistry, for instance, light curing devices are often employed to polymerize and cure light curable compositions, such as light curable composites, adhesives, and other polymerizable compositions containing photoinitiators. By way of example, a light curable bonding adhesive is often employed to attach a dental appliance such as a veneer to a patient's tooth. The adhesive is applied to the surface to be bonded, after which the veneer is placed against the tooth. The light curing device is then directed toward the veneer and actuated for a selected illumination time, emitting light energy into the resin. Because veneers are translucent, the light from the curing device passes through the veneer to the light curable adhesive. The light energy polymerizes the adhesive, maintaining the veneer firmly in place.

Typical light curing devices are designed to emit light energy in a footprint large enough to illuminate an entire tooth. In this way, all of the light curable adhesive under and surrounding the veneer is polymerized, transforming the adhesive from a liquid state to a solid state. To cure the adhesive and bond the veneer to the tooth tissue, the device may be pushed against the veneer as light energy is emitted to ensure proper seating of the veneer against the tooth, so as to ensure good bond strength. Pushing against the veneer may cause excess uncured adhesive to squeeze out around the perimeter of the veneer, which excess adhesive becomes cured as the adhesive remaining between the veneer and the tooth is cured. Thereafter, any excess cured adhesive must be physically removed by scraping or cutting, which complicates the procedure. Improper removal of excess cured adhesive can result in damage to the tooth, veneer, or surrounding soft tissues. Failure to remove excess cured resin can result in a deformed tooth structure, thereby possibly interfering with normal mastication. It can also be aesthetically unpleasing.

A more recent development is a light curing device that allows for a controlled duration of light provided to the light curable composition, which allows a dental practitioner to only partially polymerize the adhesive. Such a device, which is disclosed in U.S. Pat. No. 6,103,203, includes timing means selectively operable in a plurality of different time increments, thereby allowing fine tuning of the total amount of light energy provided to the light curable composition. With such a device, the dental practitioner may partially cure the adhesive resin, and then remove any excess resin while in a partially cured state, which is softer and more easily removed than a fully cured adhesive or other light cured composition. Nevertheless, a partially polymerized adhesive is less easily removed compared than an uncured adhesive having a more fluid or less viscous rheology compared to a partially polymerized adhesive resin. Moreover, to the extent that the adhesive resin holding the appliance to the tooth is only partially polymerized, so as to allow easy removal of uncured resin, there is a risk of dislodging the appliance from the tooth when attempting to remove excess resin.

In view of the foregoing, there is an ongoing need to provide improved apparatus and methods for bonding veneers to teeth that facilitate removal of excess adhesive resin that may be expelled from between a tooth and the applied veneer or other dental appliance.

### BRIEF SUMMARY OF THE INVENTION

The present invention is directed to a reduced footprint curing lens (referred to herein as a “spot curing lens”) to be used with a light emitting device and related methods for spot curing an adhesive resin through a veneer, overlay, inlay, crown, or other restorative appliance to adhere the appliance to a substrate (e.g., a patient's tooth). The spot curing lens and related method allows a dental practitioner to spot cure a portion of a light curable adhesive through a veneer, remove any excess uncured resin from around the perimeter of the veneer, and then light cure the remaining portion of the adhesive in order to securely bond the dental appliance to the substrate surface. This eliminates the need for grinding, breaking, or scraping hardened excess adhesive from around the veneer.

The spot curing lens includes a base configured to attach to a light emitting device, a lens body having a first end proximal to the base through which light energy enters, and a second end distal to the base that is smaller than the first end through which light energy exits the lens. The lens further includes a wall extending between the first and second ends of the lens body that at least partially inhibits transmission of curing light energy therethrough. The result is that curing light energy exiting the second end of the lens body has a pattern that is smaller than the footprint of light energy that enters the first end of the lens body. The spot curing lens allows curing of a relatively small area relative to the veneer or other restorative appliance so as to allow the dental practitioner to spot cure only a portion of the light curable adhesive without curing adhesive that may be squeezed out around the perimeter of the appliance during the procedure.

Because the lens is configured to be used with a light emitting device, the lens may be integrally connected to such a device, or the lens may be configured to be attached to a light emitting device in such a manner that light emitted from the light source of the device is able to pass into the spot curing lens and out the second end during normal use. The type of connection between the lens and the light emitting device may include a snap fit, a friction fit, a threaded fitting, a bayonet coupling, or other similar couplings.

In use, a light curable composition is applied to a surface to be bonded, such as a tooth surface, the side of the appliance proximal to the tooth surface, or both. The veneer or other dental appliance is then positioned over the substrate surface, and the light emitting device with a spot curing lens is pressed against the dental appliance to help seat the appliance against the substrate. While pressing against the appliance, the spot curing lens and dental light emitting device are used to spot cure a portion of the adhesive so that a remaining portion of the adhesive surrounding the portion that is spot cured remains uncured. The cured portion holds the appliance in place while any excess adhesive that may have been expressed from between the appliance and the substrate surface is removed. Finally, the remaining uncured adhesive is cured in order to securely bond the appliance to the substrate surface.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIGS. 1A-1D illustrate exemplary embodiments of spot curing lenses according to the invention;

FIG. 2 illustrates an alternative embodiment of an inventive spot curing lens having an outer lens body defining a hollow interior and a transparent lens portion disposed within the hollow interior;

FIGS. 3A-3D illustrate alternative transparent lens portions that may be used in the spot curing lens of FIG. 2;

FIG. 4 illustrates a spot curing lens attached to a dental light curing device that is sized and configured to fit in a hand piece holder;

FIGS. 5A-5D illustrate several exemplary fittings for removably attaching a spot curing lens according to the invention to a focusing lens attached to a light emitting device.

FIGS. 6A-6C illustrate alternative dental light curing devices with a spot curing lens attached thereto; and

FIGS. 7A-7E illustrate use of a dental light curing device with a spot curing lens to spot cure a veneer to a patient's tooth.

### DETAILED DESCRIPTION OF THE PREFERRED EMBODIMENTS

As used herein, the term “light emitting device” includes any dental light device that generates light, whether using a bulb, LED, plurality of LEDs, or other light source. It also includes any dental device that emits (even though it may not generate) light, such as a fiber optic light guide. A “light emitting device” may comprise all or part of a “dental curing light” or “device”.

As used herein, the term “spot cure” refers to a procedure of curing less than the total area of a light curable composition (e.g., through a veneer or translucent dental appliance) without curing excess light curable composition that may be squeezed out around the perimeter of the appliance.

As used herein, the term “lens” refers to any object through which light may travel and does not inherently imply any characteristics for focusing or collimating light. Hence, “spot curing lenses” according to the invention included lenses that focus and lenses that do not focus light.

The term “footprint,” as used herein, is generally made with reference to the cross-sectional shape of light emitted by a light emitting device. The general shape and dimensions of a “footprint” of light can be identified by placing an object (e.g., a generally flat object) in front of a light source and observing the size and shape of the area illuminated by the light source.

The spot curing lens of the present invention includes a base configured to attach to a light emitting device, a lens body having a proximal first end through which light energy from the light emitting device enters, and a second end distal to said base that is smaller than the first end through which light energy exits. The spot curing lens also includes a wall extending between the first and second ends of the lens body that at least partially inhibits transmission of curing light energy therethrough. Alternatively, at least a portion of the lens body may have a wall that is flat, so as to block a portion of light from a light emitting device, and an aperture through the wall that permits a portion of the light energy to pass through the aperture. Curing light energy exiting the second end of the lens body has a pattern that is smaller than the footprint of light energy emitted by a light emitting device that enters the first end of the lens body. The spot curing lens may optionally include one or more focusing lenses and/or a tip.

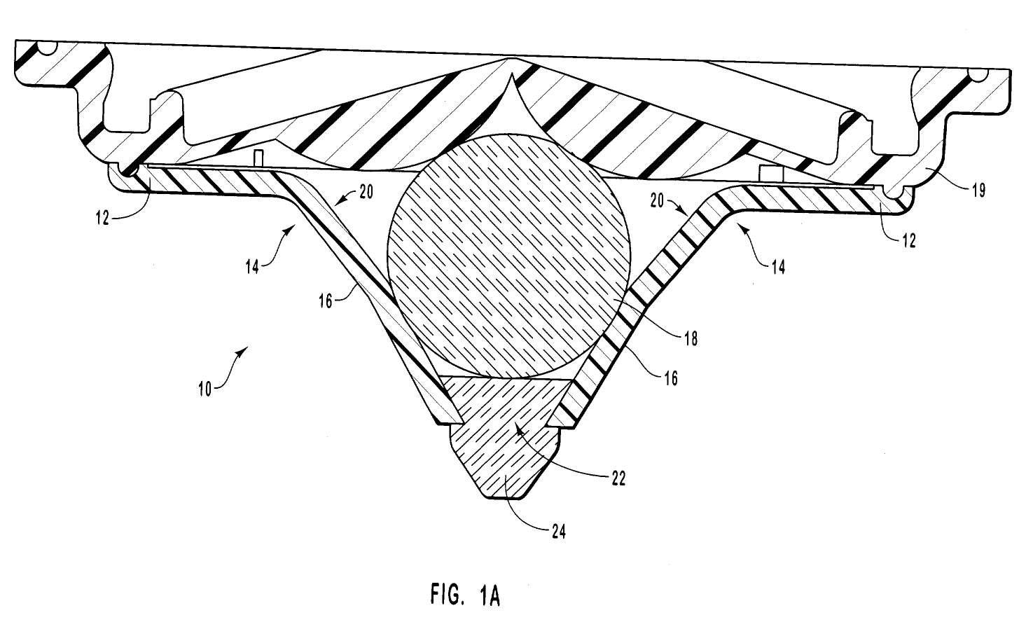

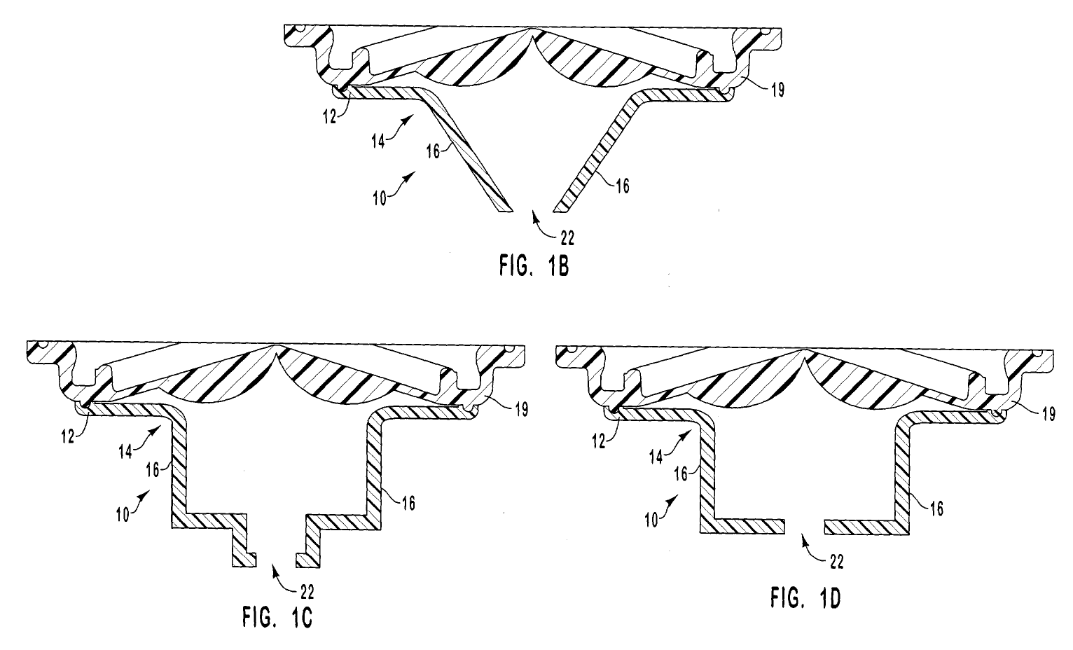

FIG. 1A illustrates an exemplary embodiment of a spot curing lens according to the present invention. Spot curing lens 10 includes a base 12, a lens body 14, a wall 16, and a spherical focusing lens 18 disposed within a hollow interior defined by lens body 14. The base 12 is configured to releasably attach the lens 10 to a light emitting device. In the embodiment shown in FIG. 1, the spot curing lens 10 is actually attached to an intermediate focusing lens 19 that is itself attached (integrally or releasably) to a light emitting device (not shown). It will be understood that the intermediate lens 19 is optional such that the spot curing lens 10 can be attached directly to the light emitting device (not shown) by any desired attachment means known in the art. For example, the spot curing lens may be to a light emitting device by means of a snap fit, a press fit, a friction fit, a threaded coupling, a bayonet coupling, or any other type of coupling. Alternatively, the base 12 may be integrally attached to the light emitting device (or intermediate lens).

The lens body 14 of the spot curing lens 10 includes a first end 20 and a second end 22, the first end 20 being proximal to the base 12, and the second end 22 being distal to the base 12. The second end 22 is smaller than the first end 20. Light energy emitted by the light emitting device enters the body 14 through the first end 20 and exits through the second end 22.

Wall 16 extends between first end 20 and second end 22. Wall 16 at least partially inhibits transmission of curing light energy through the wall so that curing light energy transmitted by the spot curing lens has a pattern or footprint that is smaller than the footprint of light energy that enters first end 20. Reducing the pattern of curing light energy allows a user of a light curing device to selectively cure a portion of a light curable composition through a dental appliance (e.g., a veneer) without curing any excess adhesive that may extend beyond the perimeter of the appliance. Although a conical lens body 14 is preferred, any lens body tapered from the first end 20 to the second end 22, or even a cylindrical lens body (as seen in FIGS. 1C and 1D) could be used. All that is required is that the lens body allow a user of the spot curing lens to cure a portion of a light curable composition without curing any excess composition extending beyond the perimeter of the dental appliance, as might occur when using the light emitting device without the spot curing lens.

In order to limit or reduce the pattern of curing light output through the spot curing lens 10, the wall 16 is at least partially opaque to curing wavelengths. The wall 16 may be completely opaque to all wavelengths or simply opaque to the component of emitted light energy comprising curing wavelengths. The latter embodiment may be accomplished by tinting the wall 16 (e.g., with UV orange) to selectively absorb and prevent curing wavelengths (e.g., blue, violet or UV) from passing through the wall 16. Because of the opacity of the wall to curing light energy, curing light energy from the light emitting device passing through the spot curing lens is emitted only through the relatively narrow second end 22. This allows a dental practitioner to selectively spot cure a portion of a light curable composition through a transparent or translucent dental appliance.

The second end 22 may be an aperture opening to lens body 14 (FIGS. 1B-1D), or it may optionally be at least partially filled by a transparent or translucent tip 24 (FIG. 1A). At least a portion of the lens body 14 may be flat. If all of it is flat, it will simply comprise a flat disk or disk-like structure (not shown) having an aperture that permits only a portion of light emitted by the light emitting device to pass there through. A light emitting tip may be attached through or over the aperture that transmits light that exits the aperture.

If a tip is present, the tip 24 is adjacent to or within second end 22. Tip 24 is transparent or translucent to curing light energy, which allows it pass through tip 24. The tip 24 may be desirable to keep foreign matter or objects from entering the lens body 14 and contaminating the spot curing lens 10. Tip 24 may be flexible or hard, as desired. It may be formed, for example, of urethane, silicone, polyethylene, or any other elastomer with suitable transmission characteristics with respect to curing light energy. Using a soft tip allows the dental practitioner to hold the dental appliance in place with the tip while reducing the risk of breaking or cracking the veneer or other appliance as the dental practitioner presses the tip 24 against the appliance.

Spot curing lens 10 may also include one or more focusing lenses, such as focusing lens 18. The curing device shown in FIG. 1A includes an intermediate lens 19 for focusing light before entering the spot curing lens 10. Focusing lens 19 collimates the light that is emitted from the light emitting device (not shown). Exemplary focusing lenses for use in focusing light energy emitted by a plurality of LEDs are described in detail in U.S. application Ser. No. 10/044,346, the disclosure of which is hereby incorporated by reference. After passing through lens 19, the light enters spherical focusing lens 18 and is further collimated before exiting out of the spot curing lens 10 through second end 22. Lenses 18 and 19 are optional, and the space they occupy in FIG. 1A could alternately be empty, allowing the curing light energy to simply enter spot curing lens 10 through first end 20 and exit through second end 22. FIG. 18B illustrates a spot curing lens 10 device of spherical lens 18. If present, focusing lenses 18, 19, or other such lenses may be formed of any transparent material known and used in the art, such as glass or plastic.

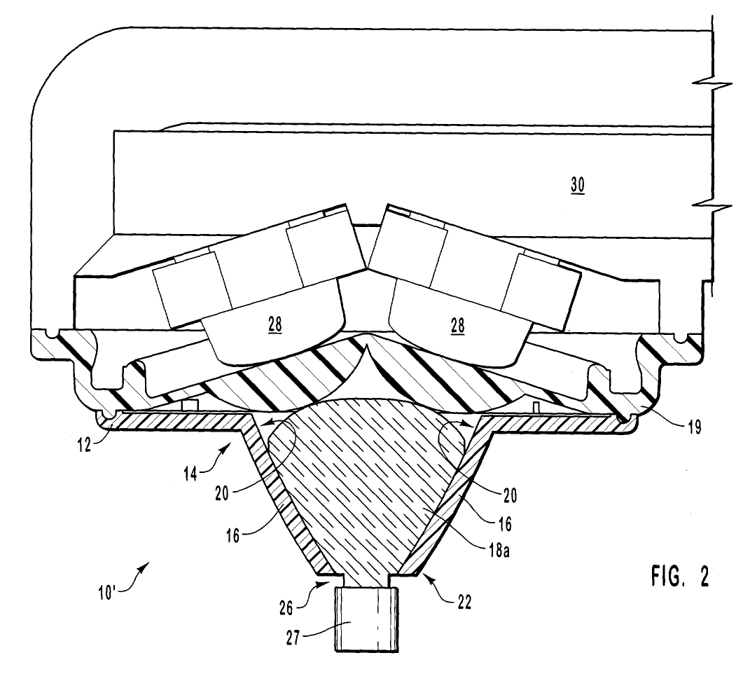

FIG. 2 illustrates an alternative embodiment of a spot curing lens 10′ attached to a light emitting device 30. Spot curing lens 10′ includes a base 12, a lens body 14, a wall 16, and an optional focusing lens 18a. Focusing lens 18a is of a different design than spherical focusing lens 18 of FIG. 1. Focusing lens 18a includes a curved surface adjacent to the first end 20 of lens body 14 through which light energy enters and a light emitting tip 26 adjacent to second end 22 of the lens body 14. The focusing lens 18a also includes a cylindrical extension 27.

Also illustrated in FIG. 2 is an array of two light sources 28, which are preferably light emitting diodes (LEDs), but may include any kind of light source, including, for example, diode lasers, or various bulbs (such as halogen bulbs, incandescent bulbs, or fluorescent bulbs).

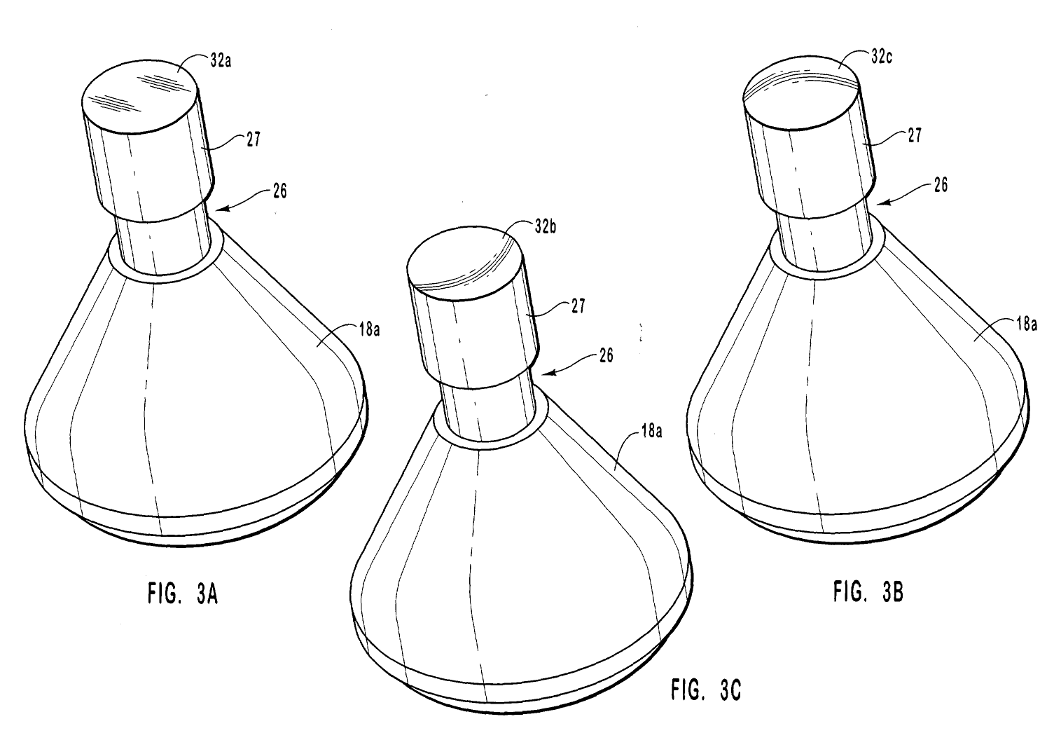

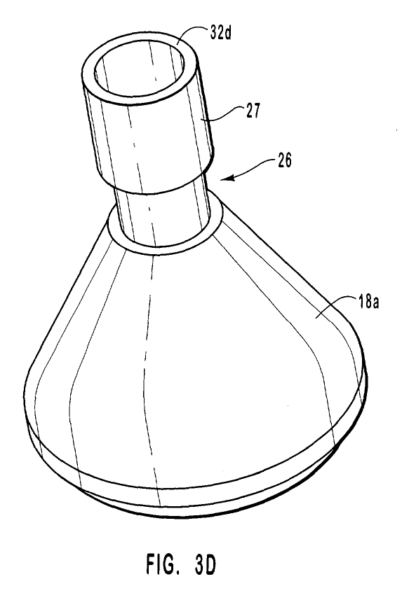

FIGS. 3A-3D illustrate a number of exemplary focusing lenses 18a having varying extensions 27 attached to the light emitting tip 26. Each exemplary tip extension 27 is either integral with focusing lens 18a or is attached to lens 18a by a mechanical fit, e.g., a friction fit. Each tip extension 27 is illustrated with a friction fit and is partially removed from lens 18a to better illustrate the friction fit. FIG. 3A illustrates a focusing lens 18a and cylindrical tip extension 27 that includes a planar outer surface 32a. FIG. 3B illustrates a focusing lens 18a having a tip extension with a convex outer surface 32b. FIG. 3C illustrates a focusing lens 18a having a tip extension 27 with a concave outer surface 32c.

FIG. 3D illustrates a focusing lens 18a having a tip extension 27 that is hollow, being open at end 32d. It should be understood that the tip extension is an optional feature that, when present, forms part of the tip 26.

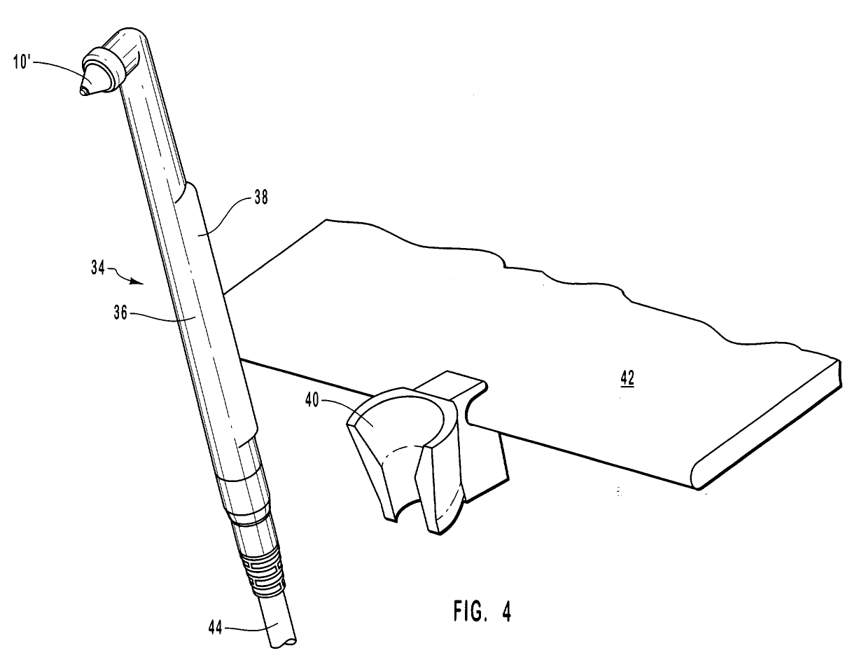

FIG. 4 illustrates a dental curing device 34 with a spot curing lens 10′ attached thereto. Exemplary dental curing lights are disclosed in U.S. application Ser. No. 10/068,103, incorporated herein by reference. Dental curing device 34 has the general configuration of a standard dental hand piece. The shape of the body 36 is generally cylindrical, being defined by a circular cross-sectional shape. It will be appreciated, however, that the cross-sectional shape of the body 36 may be configured into other shapes, including, but not limited to, square, triangular, hexagonal, oval, rectilinear shapes, and combinations thereof. The body 36 may also include small or slight irregularities or protrusions such as protrusion 38, which may be configured with control buttons (not shown) for controlling the operation of the dental curing device 34.

The generally cylindrical shape of the body 36 enables a dental practitioner to comfortably hold the dental device 34 in various positions. The body 36 of the dental curing device 34 is also useful for enabling the dental practitioner to easily rotate and move the curing device 34 into various positions during a dental procedure. The dental curing device 34 is configured in size and shape to be inserted into the holding slot 40 of a dental hand piece holding tray 42.

As shown, the dental curing device 34 is also configured to be connected with a power cord 44 at a proximal end of the body 36. Although not shown, the power cord 44 operably connects the curing device 34 to a power supply (not shown) remotely located away from the curing device 34. The remote power supply may include an electrical wall receptacle, a battery pack, a generator, a transformer, or any other power supply suitably configured for providing an appropriate supply of power to the curing device 34 for illuminating the light source (not shown) of the curing device 34, which is disposed at the distal end of the dental device 34 under spot curing lens 10′.

In one embodiment, the light source may include an LED configured to emit radiant energy that is suitable for curing light curable compositions. It will be appreciated, however, that a preferred light source may also include an LED array, a plurality of LEDs, or other light sources.

Spot curing lens according to the invention may be attachable and detachable from the distal end of a light emitting device using any known attachment means, such as with a snap fit, a friction fit, a press fit, a threaded coupling, a bayonet coupling, or any other type of coupling for enabling the spot curing lens or different types of lenses with different functionality (e.g. a larger footprint lens, or no lens) to be interchangeably used with a light emitting device according to need and preference.

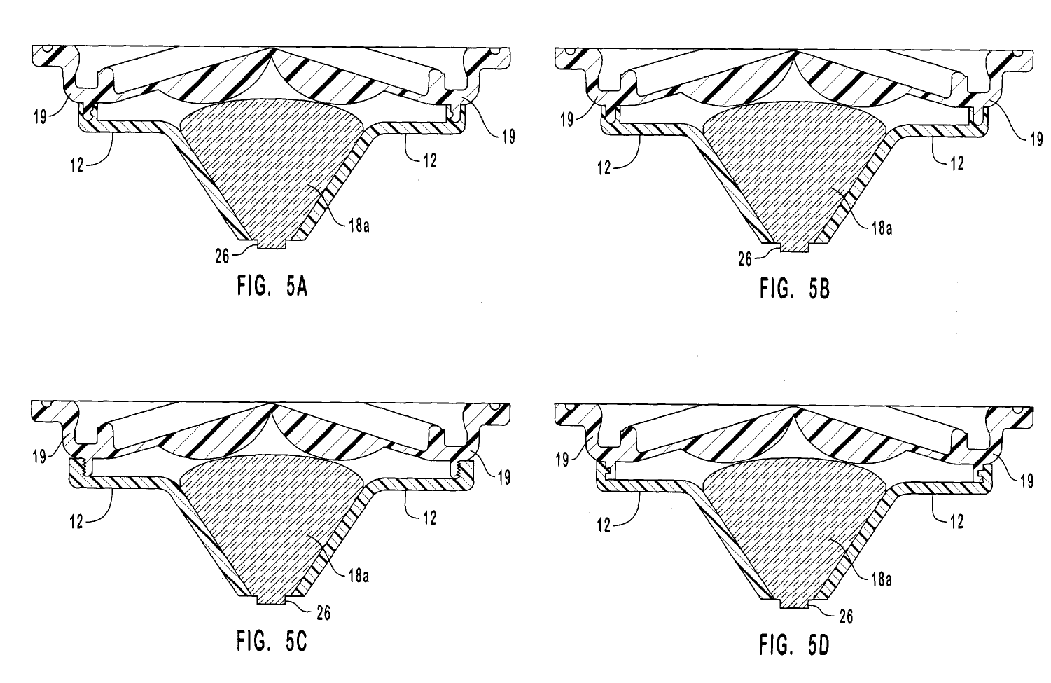

Several exemplary fittings between the base 12 and optional focusing lens 19 are illustrated in FIGS. 5A-5D. These same fittings could be used anywhere a detachable connection is desired (e.g. between focusing lens 19 and a light emitting device, or between base 12 and a light emitting device). FIG. 5A illustrates a snap fit arrangement. Focusing lens 19 includes a recess configured to retain a corresponding protrusion in base 12 in a snap-fit arrangement. FIG. 5B illustrates a friction or compression fit. Base 12 includes a recess configured to tightly receive a corresponding protrusion formed in focusing lens 19. FIG. 5C illustrates a threaded coupling. Base 12 and focusing lens 19 include corresponding grooves and raised threads, which raised threads are received in the corresponding grooves to threadably connect base 12 to focusing lens 18b. FIG. 5D illustrates a bayonet coupling. Focusing lens 19 includes a recess configured to accept a corresponding protrusion formed in base 12. Alternatively, the lens may be integrally attached to either the lens 19 or a light emitting device by, e.g., adhesive, welding, or other non-removable coupling.

According to one embodiment, the dental light curing device also includes controls for controlling the intensity and/or duration of radiant energy from the light source.

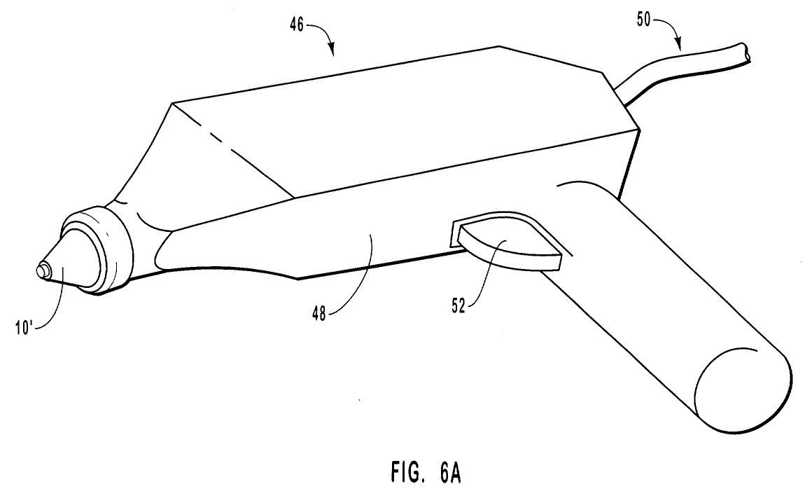

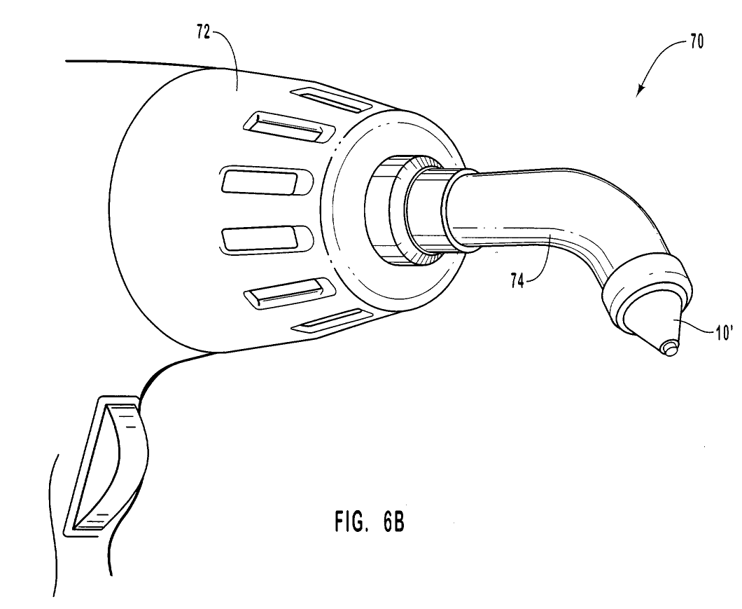

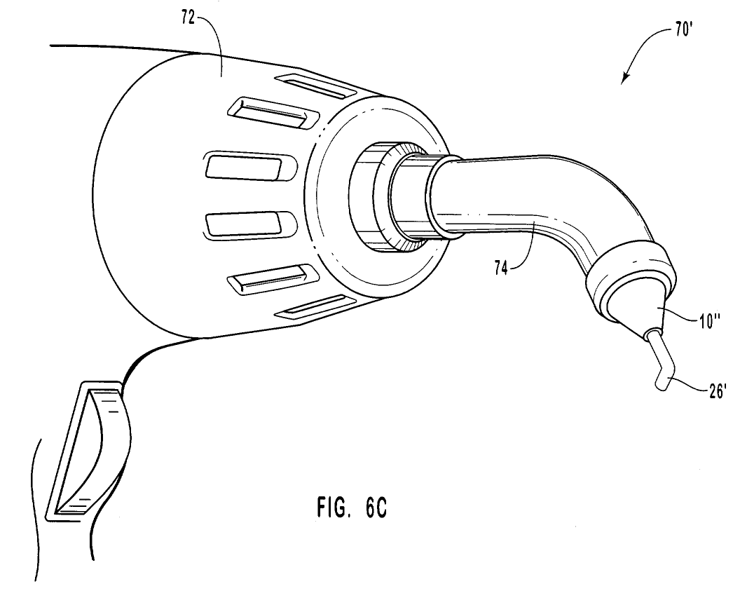

FIG. 6A illustrates an alternative dental light curing device 46 with a spot curing lens 10′ attached thereto. Light curing device 46 is comprised of a body 48 coupled to a power source (not shown) by an electrical cord 50. Device 46 includes a trigger 52 or other activator to operate the device. The distal end of device 46 may include a light source (not shown) and corresponding structure configured to couple with spot curing lens 10′. Light curing device 46 may use any kind of single or multiple light sources, including halogen bulbs, incandescent bulbs, fluorescent bulbs, laser sources, or light emitting diodes (LEDs).

Spot curing lens 10′ may be detachable from the distal end of the dental light curing device 46, such as with a snap fit, a friction fit, a threaded coupling, a bayonet coupling, or any other type of coupling for enabling the spot curing lens or different types of lenses with different functionality (e.g. a large footprint lens, or no lens) to be interchangeably used with the dental device 46 according to need and preference. Alternatively, the lens 10′ may be integral with the distal end of the dental device 46, such as with an adhesive, by welding, or with other non-removable coupling. Spot curing lens 10′ allows the dental curing device 46 to be used to spot cure a light curable composition through a veneer or other dental restorative appliance.

FIG. 6B illustrates a light curing system 70 comprising a light emitting device 72 that includes a fiber optic light guide 74 configured so as to capture and transmit light generated by a light source (not shown) disposed within the light emitting device 72. A spot curing lens 10′ according to the invention is attached to a distal end of the fiber optic light guide 74.

FIG. 6C illustrates a light curing system 70′ comprising a light emitting device 72 that includes a fiber optic light guide 74 configured so as to capture and transmit light generated by a light source (not shown) disposed within the light emitting device 72. An alternative embodiment of a spot curing lens 10″ having an elongated light emitting tip 26′ is attached to the distal end of the fiber optic light guide 74. The spot curing lens 10″ with the elongated light emitting tip 26′ is useful for spot curing dental appliances that are to be attached to hard-to-reach places, e.g., to spot cure a crown onto a molar or a veneer on the back side of an incisor or other tooth whose back side is not readily accessed using a spot curing lens having a shorter light emitting tip.

In this embodiment, the elongated light emitting tip 26′ also has a bend for convenience, although straight or curved elongated tips are within the scope of the invention. The elongated light emitting tip 26′ is transparent or translucent and acts like a light guide to channel light there through. If there is a bend in the elongated light emitting tip 26′, as in the embodiment shown in FIG. 6C, the light will typically bend through the elongated light emitting tip 26′ as if it were a fiber optic light guide.

Elongated light emitting tips can have any desired length, with lengths of 4-20 mm being preferred and lengths of 8-15 mm being more preferred. In one embodiment, the overall length of an elongated light emitting tip 26′ according to the invention is 11 mm overall, and 8 mm from the end of the lens body to the bend.

In addition to being useful in spot curing a portion of a light curable adhesive composition, elongated light emitting tips according to the invention can be inserted into deep dental preparations or root canals in order to light cure composites or sealants placed therein.

It will, of course, be appreciated that a spot curing lens with an elongated light emitting tip, such as spot curing lens 10″ illustrated in FIG. 6C, can be used with any dental curing light, including other curing lights discussed elsewhere in this specification, e.g., an LED curing light having the design illustrated in FIG. 4.

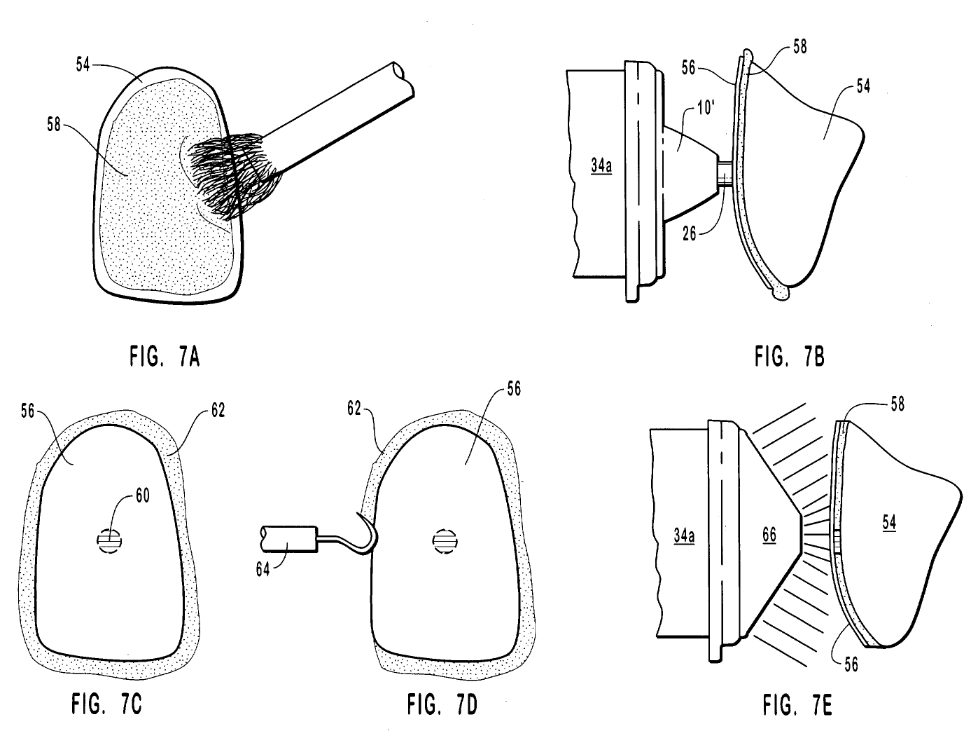

FIGS. 7A-7E illustrate an exemplary method of adhering a dental appliance to a tooth according to the invention. Although the spot curing lenses according to the invention may be used in any number of applications where spot curing is desirable, including placement of veneers, overlays, inlays, crowns, and other dental restorative appliances, use of a spot curing lens to attach a translucent porcelain veneer will be illustrated.

The first step in attaching a veneer or other appliance to a tooth involves the application of a suitable light curable adhesive to a tooth surface to be bonded, a surface of the appliance that will lie adjacent to the tooth surface, or both. FIG. 7A shows a tooth surface 54 to which a white curable adhesive 58 is applied (e.g., by means of a syringe tip coated with fibers that facilitate spreading or brushing of the light curable adhesive 58).

FIG. 7B illustrates a veneer 56 being pressed against the tooth surface 54 by a spot curing lens 10′ coupled to dental light curing device 34a, the lens 10′ having a light emitting tip 26. This helps to properly seat the veneer 56 against the tooth surface 54 while expelling any excess adhesive 58 from between the veneer 56 and tooth surface 54.

Once the veneer 56 or other appliance is positioned correctly, the dental practitioner uses the light curing device 34 with attached spot curing lens 10′ to spot cure the light curable adhesive 58 through the translucent veneer 56. FIG. 7C illustrates the veneer 56 after spot curing. The dental light curing device 34a with attached spot curing lens 10′ cures a portion 60 of the light curable adhesive 58 beneath the veneer 56. The cured portion 60 may be of any size and shape, so long as it does not extend beyond the perimeter of the veneer 56.

Before or while spot curing, excess uncured adhesive 62 may be squeezed out along the perimeter of the veneer 56 as the veneer 56 is pushed against and seated against the tooth surface 54. This uncured adhesive 62 is easily removed with a dental explorer 64 or other suitable tool from around the perimeter of the veneer 56 as seen in FIG. 7D because it is still in an uncured state. Finally, as shown in FIG. 7E, the dental practitioner cures the remainder of the light curable adhesive 58 that remains between the veneer 56 or other appliance and the tooth surface 54. The dental light curing device 34 may optionally be modified, such as by attaching a lens 66, to produce a desired footprint of light.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A spot curing lens adapted for use with a light emitting device in order to spot cure a portion of a light curable adhesive used to adhere a translucent dental appliance to a substrate, the lens comprising:
a base configured to attach to a light emitting device that emits a footprint of light energy;
a lens body having a first end proximal to said base through which footprint of light energy emitted by a light emitting device enters and a second end distal to said base that is smaller than said first end through which light energy exits; and
a wall extending between said first and second ends of the lens body that at least partially inhibits transmission of curing light energy therethrough so that curing light energy transmitted by the spot curing lens has a pattern that is smaller than the footprint of light energy that enters said first end of said lens body.

2. A spot curing lens as recited in claim 1, wherein said wall is opaque so as to block transmission of light energy therethrough.

3. A spot curing lens as recited in claim 1, wherein said wall absorbs at least some curing wavelengths and transmits other wavelengths.

4. A spot curing lens as recited in claim 1, wherein said wall is of a UV orange tint.

5. A spot curing lens as recited in claim 1, wherein said base is configured so as to releasably attach the lens to a light emitting device by a snap fit, a friction fit, a threaded coupling, or a bayonet coupling.

6. A spot curing lens as recited in claim 1, wherein said base is configured so that the lens is integrally attached to a light emitting device.

7. A spot curing lens as recited in claim 1, wherein said lens body has a hollow interior.

8. A spot curing lens as recited in claim 7, further comprising at least one focusing lens at least partially disposed within said hollow interior of said lens body.

9. A spot curing lens as recited in claim 8, wherein said focusing lens is spherical.

10. A spot curing lens as recited in claim 8, wherein said focusing lens comprises a curved surface adjacent to said first end of said lens body through which light energy enters and a light-emitting tip adjacent to said second end of said lens body through which light energy exits.

11. A spot curing lens as recited in claim 10, wherein said light-emitting tip is elongated.

12. A spot curing lens as recited in claim 11, wherein said elongated light-emitting tip has a bend.

13. A spot curing lens as recited in claim 1, further comprising a transparent or translucent tip adjacent to said second end of said lens body through which light energy exits.

14. A spot curing lens as recited in claim 13, wherein said tip is flexible.

15. A spot curing lens as recited in claim 13, wherein said tip comprises an elastomer.

16. A spot curing lens as recited in claim 15, wherein said elastomer comprises at least one of urethane, silicone, or polyethylene.

17. A spot curing lens as recited in claim 13, wherein an outer surface of said tip is convex.

18. A spot curing lens as recited in claim 13, wherein an outer surface of said tip is concave.

19. A spot curing lens as recited in claim 13, wherein an outer surface of said tip is planar.

20. A spot curing lens as recited in claim 13, wherein said tip is hollow.

21. A spot curing lens as recited in claim 13, wherein said tip is elongated.

22. A spot curing lens as recited in claim 13, wherein said elongated tip has a bend.

23. A spot curing lens as recited in claim 1, wherein said lens body housing is tapered from said first end to said second end.

24. A spot curing lens as recited in claim 23, wherein said lens body is conical.

25. A spot curing lens as recited in claim 1, wherein at least a portion of said lens body is cylindrical.

26. A spot curing lens adapted for use with a light emitting device in order to spot cure a portion of a light curable adhesive used to adhere a translucent dental appliance to a substrate, the lens comprising:
a base configured to attach to a light emitting device that emits a footprint of light energy;
a lens body having a wall that blocks a portion of light energy emitted by a light emitting device to which the spot curing lens is attached and an aperture through the wall that allows only a portion of the footprint of light energy to pass there through; and
a light emitting tip attached to said lens body adjacent to or through said aperture that transmits light energy passing through said aperture.

27. A spot curing lens as recited in claim 26, wherein at least a portion of said lens body is cylindrical.

28. A spot curing lens as recited in claim 26, wherein at least a portion of said lens body is conical.

29. A spot curing lens as recited in claim 26, wherein at least a portion of said lens body is flat.

30. A light curing system for use in adhering a translucent dental appliance to a substrate, the light curing system comprising:
a light emitting device that emits a footprint of light energy;
a spot curing lens adapted for use with the light emitting device in order to spot cure a portion of a light curable adhesive used to adhere a translucent dental appliance to a substrate, the lens comprising:
a base configured to removably attach the spot curing lens to the light emitting device;
a lens body having a first end proximal to said base through which light energy emitted by the light emitting device enters and a second end distal to said base that is smaller than said first end through which light energy exits; and
a wall extending between said first and second ends of the lens body that at least partially inhibits transmission of curing light energy therethrough so that curing light energy transmitted by the spot curing lens has a pattern that is smaller than the footprint of light energy that enters said first end of said lens body; and
curing means for light curing a remaining portion of a light curable adhesive that has been spot cured using the spot curing lens.

31. A light curing system as recited in claim 30, wherein said light emitting device includes a light source that comprises at least one of a halogen bulb, an incandescent bulb, a fluorescent bulb, or a laser source.

32. A light curing system as recited in claim 30, wherein said light emitting device includes a light source comprising at least one LED or LED array.

33. A light curing system as recited in claim 30, wherein said light emitting device includes a fiber optic light guide configured to capture and transmit light generated by a light source of the light emitting device.

34. A light curing system as recited in claim 30, wherein said curing means comprises said light emitting device separated from said spot curing lens so that the footprint of light energy emitted by said light emitting device is sufficiently large to cure the remaining portion of a light curable adhesive that has been spot cured using the spot curing lens.

35. A light curing system as recited in claim 30, wherein said curing means comprises a focusing lens, removably attached to said light emitting device in place of the spot curing lens, that transmits an altered footprint of light energy sufficiently large to cure the remaining portion of a light curable adhesive that has been spot cured using the spot curing lens.

36. A light curing system for use in adhering a translucent dental appliance to a substrate, the light curing system comprising:
a light emitting device that emits a footprint of light energy;
a spot curing lens adapted for use with the light emitting device in order to spot cure a portion of a light curable adhesive used to adhere a translucent dental appliance to a substrate, the lens comprising:
a base configured to attach to a light emitting device that emits a footprint of light energy;
a lens body having a wall that blocks a portion of light energy emitted by a light emitting device to which the spot curing lens is attached and an aperture through the wall that allows only a portion of the footprint of light energy to pass there through; and
a light emitting tip attached to said lens body adjacent to or through said aperture that transmits light energy passing through said aperture; and
curing means for light curing a remaining portion of a light curable adhesive that has been spot cured using the spot curing lens.

37. A method for adhering a translucent dental appliance to a substrate, comprising:
applying a light curable adhesive to a surface of at least one of a translucent dental appliance or a substrate to which the translucent dental appliance is to be adhered;
positioning the translucent dental appliance against the substrate surface;
spot curing a portion of said light curable adhesive so that a remaining portion of the adhesive surrounding the portion that is spot cured remains uncured;
removing any excess light curable adhesive that may have been expressed from between the dental appliance and the substrate surface when positioning the dental appliance against the substrate surface; and
light curing the remaining portion of the adhesive in order to securely bond the dental appliance to the substrate surface.

38. A method as recited in claim 37, wherein said dental appliance comprises translucent porcelain.

39. A method as recited in claim 37, wherein said dental appliance comprises at least one of an overlay, an inlay, or a crown.

40. A method as recited in claim 37, wherein said dental appliance comprises a veneer.

41. A method as recited in claim 37, wherein spot curing a portion of said light curable adhesive is performed with a spot curing lens attached to a light emitting device.

42. A method as recited in claim 37, wherein light curing the remaining portion of the adhesive is performed with a light emitting device comprising one or more LEDS or LED arrays.

43. A method as recited in claim 37, wherein light curing the remaining portion of the adhesive is performed using a focusing lens attached to a light emitting device.
